(19) United States
(12) Patent Application Publication
(10) Pub. No.: US 2024/0149324 A1
(43) Pub. Date: May 9, 2024

(54) METHOD FOR PRODUCING PLATE PIECE AND PUNCHING MACHINE

(71) Applicant: TOYOTA JIDOSHA KABUSHIKI KAISHA, Toyota-shi (JP)

(72) Inventors: Takashi TAKAHASHI, Toyota-shi (JP); Hokuto SUZUKI, Nagoya-shi, (JP); Yuma IWAMOTO, Toyota-shi (JP)

(73) Assignee: TOYOTA JIDOSHA KABUSHIKI KAISHA, Toyota-shi (JP)

(21) Appl. No.: 18/492,249

(22) Filed: Oct. 23, 2023

(30) Foreign Application Priority Data
Nov. 9, 2022 (JP) 2022-179832

(51) Int. Cl. B21D 28/14; B21D 28/22

(52) U.S. Cl. CPC B21D 28/14; B21D 28/22

(57) ABSTRACT

A technique disclosed herein relates to a method for producing a plate piece including a partial outline and a remaining outline continuous from the partial outline. The method disclosed herein may comprise removing an outer region external to the partial outline from a plate workpiece by a first punch (first punching process); and punching out an inner region internal to the remaining outline by a second punch from the plate workpiece in which the outer region has been removed while applying a block to a side surface of the plate workpiece along the partial outline (second punching process). In the second punching process, by applying the block to the side surface of the already-formed partial outline, deformation of the partial outline can be suppressed when the inner region internal to the remaining outline is punched out by the second punch.

### REFERENCE TO RELATED APPLICATION

This application claims priority from Japanese Patent Application No. 2022-179832 filed on Nov. 9, 2022, the entire content of which is incorporated herein by reference.

### BACKGROUND ART

The technologies disclosed herein relate to a method for producing a plate piece that includes a partial outline and a remaining outline continuous therefrom, and a punching machine suitable for the method. The punching machine may be called by various names such as a punch press machine, a puncher, a stamping machine, a backing-out punch machine, or a die-out press machine.

A plate piece having a predetermined outline is often produced by a punching machine. For example, Japanese Patent Application Publication 2012-178933 describes a technique for making a stator for an electric motor by stacking multiple plate pieces (segment core pieces) having a predetermined outline. Japanese Patent Application Publication 2014-207783 describes a punching machine for producing segment core pieces of a stator.

### DESCRIPTION

If a plate piece having a predetermined outline is punched out by a single punch, the desired shape accuracy may not be achieved. For convenience of explanation, the overall outline of the plate piece is divided into a partial outline and a remaining outline continuous from the partial outline. It is conceivable that only the partial outline is formed in a first punching, and then the remaining outline is punched out in a second punching. However, in this case, the partial outline may be deformed in the second punching. The disclosure herein provides a method for producing a plate piece having a predetermined outline that ensures that a partial outline formed in a first punching process is not deformed in a second punching process. The disclosure herein also provides a punching machine suitable for such a production method.

One of techniques disclosed herein relates to a method for producing a plate piece. The plate piece includes a partial outline and a remaining outline continuous from the partial outline. The method disclosed herein may comprise removing an outer region external to the partial outline from a plate workpiece by a first punch (first punching process); and punching out an inner region internal to the remaining outline by a second punch from the plate workpiece in which the outer region has been removed while applying a block to a side surface of the plate workpiece along the partial outline (second punching process). In the second punching process, by applying the block to the side surface of the already-formed partial outline, deformation of the partial outline can be suppressed when the inner region internal to the remaining outline is punched out by the second punch. Hereinafter, for the simplicity of explanation, the “side surface of the plate workpiece along the partial outline” may be referred to simply as “side surface of the partial outline”.

The present disclosure also provides a punching machine suitable for the production method described above. The punching machine may comprise a first punch configured to remove an outer region external to a partial outline from a plate workpiece, and a second punch configured to punch out an inner region internal to a remaining outline from the remaining workpiece (the plate workpiece in which the outer region has been removed). The second punch may comprise a main protrusion for punching out the inner region from the remaining workpiece, and a block. The block contacts a side surface of the remaining workpiece along the partial outline when the main protrusion is pressed against the remaining workpiece. Height of the block is greater than height of the main protrusion. The block contacts the side surface of the remaining workpiece along the partial outline before the main protrusion contacts the remaining workpiece.

A difference in height between the block and the main protrusion may be greater than thickness of the remaining workpiece. This allows the block to contact the entire side surface of the partial outline before the main protrusion contacts the remaining workpiece.

The main protrusion may be configured such that edges thereof corresponding to the partial outline and the remaining outline form an acute angle therebetween.

Details and further improvements of the techniques disclosed herein are described in “EMBODIMENTS” below.

### BRIEF DESCRIPTION OF THE DRAWINGS

FIG. 1 shows a plan view, a perspective view and an enlarged view of a plate piece (segment core piece of a stator core for an electric motor) produced by a production method according to an embodiment.

FIG. 2 shows diagrams for explaining a first punching process.

FIG. 3 shows a perspective view of a first punch.

FIG. 4 shows diagrams for explaining a second punching process (perspective view of a second punch).

FIGS. 5A and 5B show cross-sectional diagrams along a line V-V in FIG. 4.

FIGS. 6A to 6F show diagrams for explaining a punching machine.

### EMBODIMENTS

Some features of the techniques disclosed herein are listed below.

A plate piece includes a partial outline and a remaining outline continuous from the partial outline. A method disclosed herein comprises removing an outer region external to the partial outline from a plate workpiece by a first punch (first punching process) (the plate workpiece in which the outer region has been removed is referred to as a remaining workpiece hereinafter); and punching out an inner region internal to the remaining outline by a second punch from the remaining workpiece while applying a block to a side surface of the partial outline (a side surface of the remaining workpiece along the partial outline) (second punching process). In the second punching process, by applying the block to the side surface of the already-formed partial outline, deformation of the partial outline can be suppressed when the inner region internal to the remaining outline is punched out by the second punch.

The second punch comprises the block and a main protrusion for punching out the inner region, and height of the block may be greater than height of the main protrusion. This allows the block to contact the side surface of the partial outline before the main protrusion contacts the remaining workpiece when the second punch is pressed against the remaining workpiece. Since the second punch is provided with the main protrusion and the block, the production cost can be reduced.

A difference in height between the block and the main protrusion may be greater than thickness of the remaining workpiece. This allows the block to contact the entire side surface of the partial outline before the main protrusion contacts the remaining workpiece.

The partial outline and the remaining outline may form an acute angle at a site where they connect to each other. The production method described above is suitable for accurately forming an acute corner of the plate piece.

An example of the plate piece is one of a plurality of segment cores that constitute a core of an electric motor. An example of the partial outline is a part of the plate piece that contacts an adjacent segment core. The core is formed by arranging the plurality of segment cores in an annular pattern. The boundaries between adjacent segment cores require high accuracy. The production method described above is suitable for producing such segment cores.

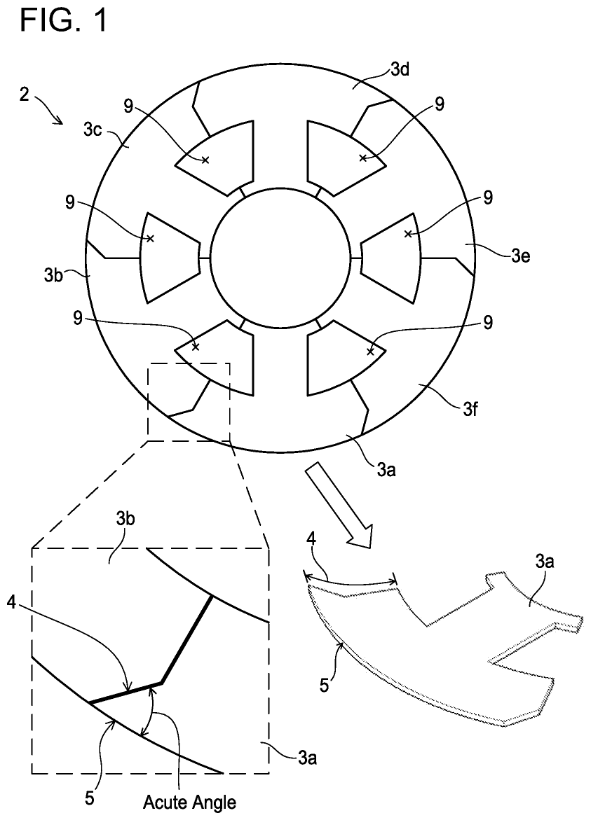

A production method according to an embodiment is described with reference to the drawings. First, a plate piece produced by the production method according to the embodiment is described. The plate piece is a segment core piece 3 of a stator 2 for an electric motor. FIG. 1 shows a plan view of the stator 2 and a perspective view of the segment core piece 3. The stator 2 is formed of a stack of multiple metal disks. The metal disks are formed of electromagnetic steel plates. The stacked multiple metal disks form a cylindrical shape and each have a plurality of through holes 9. A coil winding extends through each through hole.

As shown in FIG. 1, one metal disk is formed of six segment core pieces 3a to 3f. The six segment core pieces 3a to 3f are arranged in an annular pattern to form one core plate (metal disk). To refer to one of the segment core pieces 3a to 3f without distinction, it is referred to as a segment core piece 3. The segment core piece 3 is formed of a metal plate (electromagnetic steel plate) having thickness of 0.1 to 1.0 [mm].

For convenience of explanation, the outline of the segment core piece 3 is divided into a partial outline 4 and a remaining outline 5. The partial outline 4 refers to a part of the outline of the segment core piece 3 that is to contact an adjacent segment core piece 3 contact in the stator 2. The remaining outline 5 refers to the remaining part of the outline of the segment core piece 3, with the partial outline 4 excluded. In other words, the remaining outline 5 is continuous from the partial outline 4.

The lower left diagram in FIG. 1 is an enlarged view of an area near a boundary between adjacent segment core pieces 3. As shown in the lower left diagram, the partial outline 4 and the remaining outline 5 forms an acute angle at the site where they connect to each other. In the lower left diagram, the thick line corresponds to the partial outline 4. The segment core piece 3 (plate piece) is produced by punching processes. If a plate piece that has an outline including an acute angle is produced in a single punching process, the acute angle portion may not be formed accurately (the outline may not be formed accurately at the acute angle portion). In the production method according to the embodiment, the segment core piece 3 is produced by two punching processes.

First Punching Process

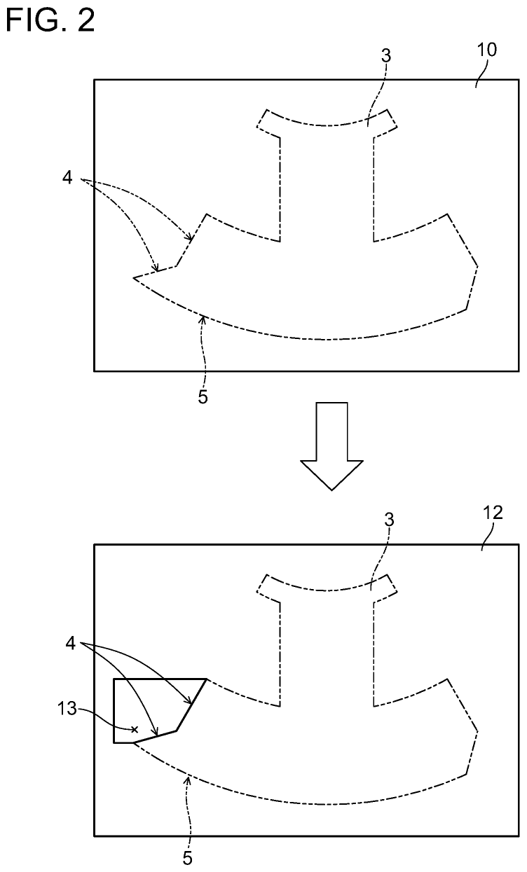

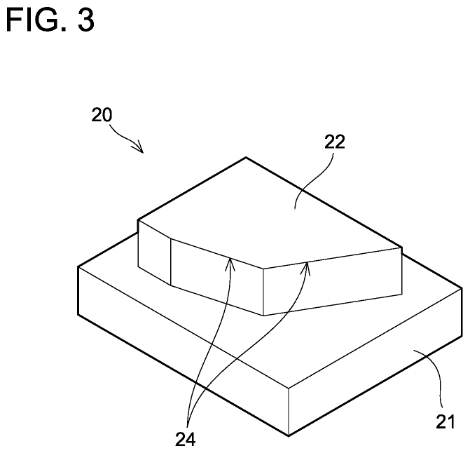

A first punching process is described with reference to FIGS. 2 and 3. In the first punching process, an outer region external to the partial outline 4 is removed from a plate workpiece 10 by a first punch. The upper diagram in FIG. 2 shows the plate workpiece 10 before the outer region is punched out. In the upper diagram in FIG. 2, the entire outline of the segment core piece 3 (the partial outline 4 and the remaining outline 5) is drawn with a virtual line on the plate workpiece 10.

The lower diagram in FIG. 2 shows the plate workpiece with the outer region external to the partial outline 4 removed therefrom. For convenience of explanation, the plate workpiece with the outer region external to the partial outline 4 removed therefrom is referred to as a remaining workpiece 12. The remaining workpiece 12 has a hole 13 therein formed by the first punch. The edge of the hole 13 includes the partial outline 4. The area of the hole 13 corresponds to the outer region external to the partial outline 4. In the lower diagram in FIG. 2, the remaining outline 5 of the segment core piece 3 is drawn with a virtual line on the remaining workpiece 12.

FIG. 3 shows a perspective view of a first punch 20. The first punch 20 comprises a base 21 and a main protrusion 22. The base 21 is supported by an actuator (not shown). The distal end edge of the main protrusion 22 of the first punch 20 includes a partial edge 24 corresponding to the partial outline 4 of the segment core piece 3. The actuator presses the first punch 20 against the plate workpiece 10 to punch out the outer region external to the partial outline 4 from the plate workpiece 10. In other words, the outer region external to the partial outline 4 is removed from the plate workpiece 10.

A punching machine for producing the segment core pieces 3 comprises a first die that receives the first punch 20, however, the first die is not shown in the drawings. The first die has a recess corresponding to the main protrusion 22 of the first punch 20. The plate workpiece 10 is placed on the first die and the first punch is pressed against the plate workpiece 10 from above. The main protrusion 22 punches the outer region out from the plate workpiece 10, so that the remaining workpiece 12 is obtained.

Second Punching Process

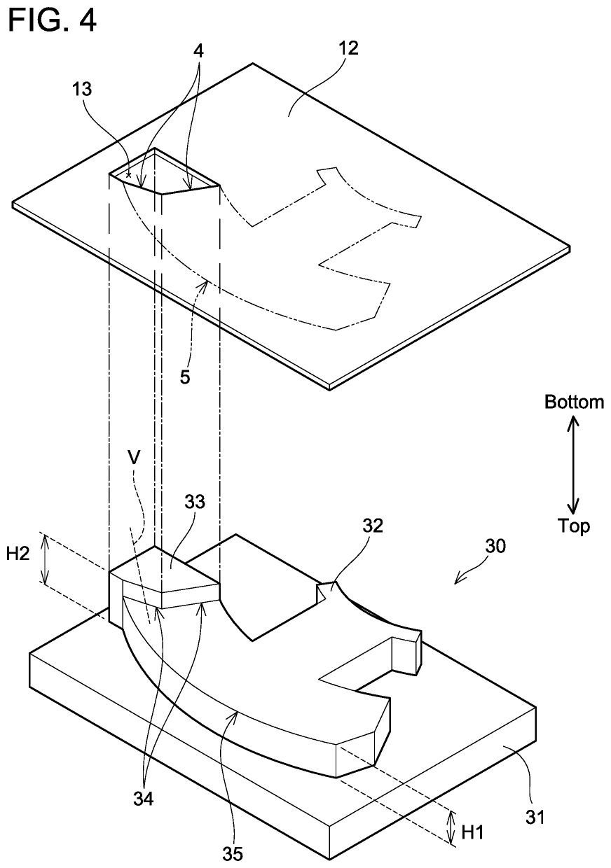

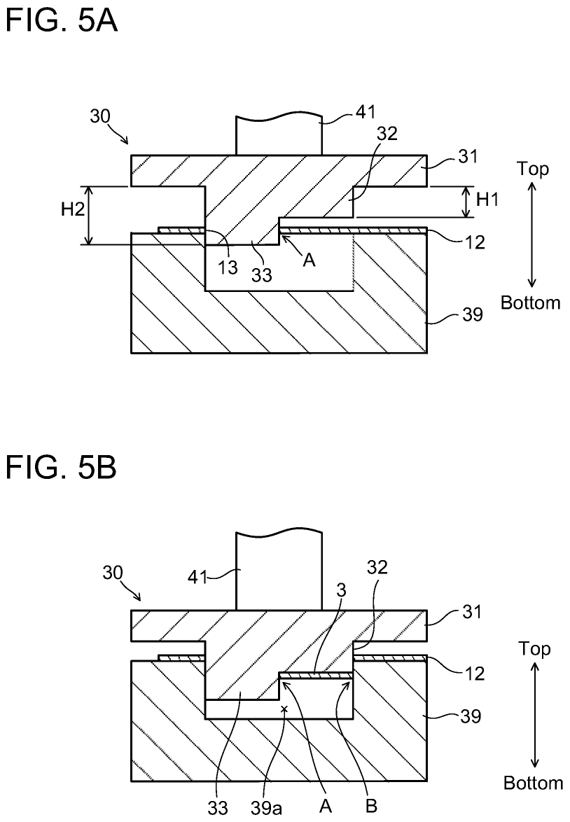

A second punching process is described with reference to FIGS. 4 and 5. In the second punching process, an inner region internal to the retaining outline 5 is punched out from the retaining workpiece 12 by a second punch 30 while a block 33 is applied to a side surface of the partial outline 4 of the retaining workpiece 12. The inner region internal to the remaining outline 5 corresponds to the segment core piece 3. As mentioned earlier, “side surface of the partial outline 4” means the side surface of the remaining workpiece 12 along the partial outline 4.

The upper diagram in FIG. 4 shows the remaining workpiece 12, and the lower diagram in FIG. 4 shows the second punch 30. FIGS. 5A and 5B shows cross-sectional diagrams along a dashed line V in FIG. 4. In other words, FIGS. 5A and 5B show cross-sections of the second punch 30 along the dashed line V in FIG. 4 and cross-sections of the remaining workpiece 12 corresponding to those cross-sections.

The diagrams in FIG. 4 are depicted with the top and bottom reversed. That is, the second punch 30 is pressed against the remaining workpiece 12 from above. The remaining workpiece 12 is placed on a second die. The second die is omitted in FIG. 4. FIGS. 5A and 5B show a second die 39. The punching machine also comprises an actuator that presses the second punch 30 against the remaining workpiece 12, however, the actuator is omitted in FIG. 4. FIGS. 5A and 5B show an actuator 41.

The second punch 30 comprises a base 31, a main protrusion 32, and a block 33. The distal end edge of the main protrusion 32 is equal to the overall outline of the segment core piece 3. The block 33 contacts a partial edge 34 of the distal end edge of the main protrusion 32 that corresponds to the partial outline 4. The distal end edge of the block 33 is equal to the outline of the main protrusion 22 of the first punch 20. However, the block 33 may be smaller than the main protrusion 22 of the first punch 20, as long as the block 33 includes an edge corresponding to the partial outline 4.

A portion of the distal end edge of the main protrusion 32 excluding the partial edge 34 is a remaining edge 35. The remaining edge 35 has the same shape as the remaining outline 5 of the segment core piece 3.

Height H2 of the block 33 from the base 31 is greater than height H1 of the main protrusion 32 from the base 31. The difference in height between the block 33 and the main protrusion 32 (H2-H1) is greater than the thickness of the remaining workpiece 12. As mentioned earlier, the remaining workpiece 12 has the hole 13 corresponding to the outer area external to the partial outline 4. The base 31 of the second punch 30 is supported by the actuator 41. The actuator 41 presses the second punch 30 against the remaining workpiece 12. The remaining workpiece 12 is placed on the second die 39 (see FIGS. 5A and 5B).

As the second punch 30 is brought closer to the remaining workpiece 12, the block 33 passes through the hole 13 of the remaining workpiece 12 before the main protrusion 32 contacts the remaining workpiece 12. FIG. 5A shows the block 33 in the hole 13. A side surface of the block 33 contacts the side surface of the partial outline 4 (the side surface of the remaining workpiece 12 along the partial outline 4). An arrow A in FIG. 5A indicates the site of contact between the side surface of the partial outline 4 and the block 33. In the state shown in FIG. 5A, the block 33 has passed through the hole 13, but the distal end of the main protrusion 32 is not in contact with the remaining workpiece 12.

As the second punch 30 is brought even closer to the remaining workpiece 12, the main protrusion 32 punches out the inner region internal to the remaining outline 5 from the remaining workpiece 12 (see FIG. 5B). That is, the punching machine punches the inner region internal to the remaining outline 5 out from the remaining workpiece 12 while the block 33 is applied to the side surface of the partial outline 4. An arrow B in FIG. 5B points to the edge of the inner region punched out by the main protrusion 32. The edge of the punched inner region contacts a side surface of a recess 39a of the second die 39. During the punching-out of the inner region, the block 33 is in contact with the side surface of the partial outline 4 (see the site the arrow A points to in FIG. 5B). The inner region is interposed between the side surface of the recess 39a of the second die 39 and a side surface of the block 33. Therefore, during the punching-out of the inner region, the partial outline 4 is not deformed and retains its shape. The angle between the partial outline 4 and the retaining outline 5 of the segment core piece 3 is an acute angle (see FIG. 1). The production method (punching machine) according to the embodiment allows a plate piece (segment core piece 3) that has an acute-angled outline to be punched out from a plate workpiece with high accuracy.

If the block 33 is not applied to the side surface of the partial outline 4, the remaining workpiece 12 will expand toward the outside of the partial outline 4 when the inner region is punched out by the second punch 30. The block 33 suppresses such expansion of the remaining workpiece 12 when the inner region is punched out by the second punch 30.

The partial edge 34 corresponding to the partial outline 4 and the remaining edge 35 corresponding to the remaining outline 5 of the main protrusion 32 form an acute angle therebetween (see FIG. 4). In other words, a portion of the main protrusion 32 that corresponds to the site where the partial outline 4 and the remaining outline 5 of the plate piece (segment core piece 3) connect to each other has an acute angle.

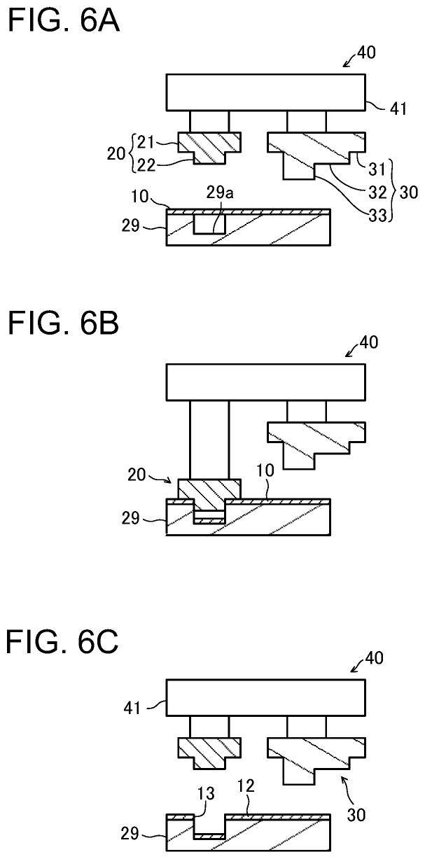

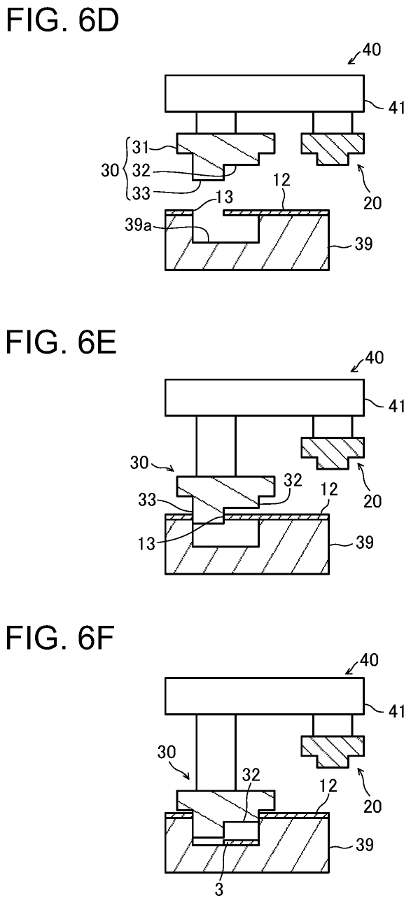

FIGS. 6A to 6F show a punching machine 40 for producing segment core pieces 3. FIGS. 6A to 6F correspond to the cross section along the dashed line V in FIG. 4.

The punching machine 40 comprises the first punch 20 and the second punch 30 as described earlier. The punching machine 40 also comprises the first die 29 corresponding to the first punch 20 and the second die 39 corresponding to the second punch 30. By sandwiching the plate workpiece between a punch and its corresponding die, a region corresponding to the protrusion of the punch will be punched out.

FIG. 6A through FIG. 6F show an operation sequence of the punching machine 40. FIG. 6A through FIG. 6C correspond to the first punching process, and FIG. 6D through FIG. 6F correspond to the second punching process.

The plate workpiece 10 is set on the first die 29. The actuator 41 sets the first punch 20 such that the main protrusion 22 is positioned directly above the recess 29a of the first die 29 (FIG. 6A). The actuator 41 moves the first punch 20 closer to the plate workpiece 10 to press the main protrusion 22 against the plate workpiece 10 (FIG. 6B). The outer region external to the partial outline is thereby removed from the plate workpiece. As a result, the hole 13 corresponding to the outer region external to the partial outline is formed in the plate workpiece (remaining workpiece 12) (FIG. 6C).

The punching machine 40 then replaces the first die 29 with the second die 39 and the first punch 20 with the second punch 30. The remaining workpiece 12 is set on the second die 39. The second punch 30 is set such that the main protrusion 32 and the block 33 are positioned directly above the recess 39a of the second die 39 (FIG. 6D). The block 33 is positioned directly above the hole 13 formed in the remaining workpiece 12. The punches and dies are replaced by a tool changer of the punching machine 40. The tool changer is well known and thus illustration and description thereof are omitted.

The actuator 41 moves the second punch 30 closer to the remaining workpiece 12. Before the main protrusion 32 reaches the remaining workpiece 12, the block 33 enters the hole 13 (FIG. 6E). As mentioned earlier, the block 33 contacts the side surface of the partial outline 4 of the remaining workpiece 12.

The actuator 41 lowers the second punch 30 further. The main protrusion 32 punches out the inner region internal to the remaining outline 5 from the remaining workpiece 12 (FIG. 6F). The punched inner region corresponds to a segment core piece 3. As mentioned earlier, the second punch 30 punches out the inner region internal to the retaining outline (i.e., segment core piece 3) from the retaining workpiece 12 by the main protrusion 32 while applying the block 33 to the side surface of the partial outline of the retaining workpiece 12. The punching machine 40 is suitable for the production method (method for producing a plate piece) described above.

The block 33 also contributes to the accurate positioning of the remaining workpiece 12 relative to the second punch 30. By the block 33 contacting the side surface of the partial outline 4 of the remaining workpiece 12, the remaining workpiece 12 is accurately positioned relative to the second punch 30.

The followings are some notes on the techniques described in the embodiment. The shape of plate piece that can be produced by the production method and punching machine according to the embodiment is not limited to the shape of a segment core piece 3.

The remaining outline 5 is connected to both ends of the partial outline 4. The partial outline 4 and the remaining outline 5 may form an acute angle therebetween only at one end of the partial outline 4. The partial outline 4 and the remaining outline 5 may form acute angles therebetween at both ends of the partial outline 4.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A method for producing a plate piece including a partial outline and a remaining outline continuous from the partial outline, the method comprising:
removing an outer region external to the partial outline from a plate workpiece by a first punch; and
punching out an inner region internal to the remaining outline by a second punch from the plate workpiece in which the outer region has been removed while applying a block to a side surface of the plate workpiece along the partial outline.

2. The method of claim 1, wherein
the second punch comprises:
the block; and
a main protrusion for punching out the inner region, and
height of the block is greater than height of the main protrusion.

3. The method of claim 2, wherein a difference in height between the block and the main protrusion is greater than thickness of the plate workpiece.

4. The method of claim 1, wherein the partial outline and the remaining outline form an acute angle at a site where they connect to each other.

5. The method of claim 1, wherein
the plate piece is one of a plurality of segment cores that constitute a core of an electric motor, and
the partial outline of the plate piece contacts an adjacent segment core.

6. A punching machine configured to produce a plate piece that includes a partial outline and a remaining outline continuous from the partial outline, the punching machine comprising:
a first punch configured to remove an outer region external to the partial outline from a plate workpiece; and
a second punch configured to punch out an inner region internal to the remaining outline from the plate workpiece in which the outer region has been removed,
wherein
the second punch comprises:
a main protrusion for punching out the inner region; and
a block configured to be applied to a side surface of the plate workpiece along the partial outline, wherein height of the block is greater than height of the main protrusion.

7. The punching machine of claim 6, wherein a difference in height between the block and the main protrusion is greater than thickness of the plate workpiece.

8. The punching machine of claim 6, wherein the main protrusion is configured such that edges thereof corresponding to the partial outline and the remaining outline form an acute angle.
